(19) United States
(12) Patent Application Publication
(10) Pub. No.: US 2007/0179677 A1
(43) Pub. Date: Aug. 2, 2007

(54) Self contained bench top enclosure temperature control system

(75) Inventor: Munmaya Kumar Mishra, Richmond, VA (US)

Correspondence Address: POLYMER INNOVATION, LLC;(M.K.MISHRA), 11804 SUMMER STREAM DRIVE, RICHMOND, VA, 23233, US

(73) Assignee: POLYMER INNOVATION, LLC

(21) Appl. No.: 10/987,506

(22) Filed: Nov. 15, 2004

Related U.S. Application Data
(60) Provisional application No. 60/524,570, filed on Nov. 25, 2003.

(51) Int. Cl. G05D 23/00

(52) U.S. Cl. 700/300

(57) ABSTRACT

A self contained bench top enclosure temperature control system that includes a heating device which is an infrared heat producing electrical bulb and a temperature controller and with or without a cooling device which is a fan designed to blow ambient air has been described.

### BACKGROUND OF THE INVENTION

The present invention relates to temperature control systems for controlling the temperature of a target such as a chemical reaction, polymerization, liquid, fluid, solvent-solute system or any other matter of which the temperature needs to be controlled. More particularly, the present invention relates to a self contained bench top enclosure temperature control system comprises a heating device which is an infrared heat producing electrical bulb; a cooling device which is a fan designed to blow ambient air; a temperature controller having input terminals that receives said input temperature signal from the target and having an electronic circuit that generates either heater control signal thus directs said heater or infrared heat producing bulb to glow to add heat to the target until it reaches a set point or generates cooler control signal directs said fan to blow cold ambient air to the target when said temperature of the target exceeds a set point. A temperature controller generates the heater control signal and the cooler control signal as respective functions of both sensed temperatures.

In the laboratory, the people who are skilled in the art of chemical synthesis or polymerization uses heating mantels and a separate temperature controller unit to control the output signal from a target which then directs the heating mantel to add heat to the reaction. There are few drawbacks in this type of setup. One has to need a separate heating unit such as a heating mantel and a temperature controller; and both the components need to be connected properly to function. The visual observation of the chemical reaction or polymerization may not be possible because the reaction flask or resin kettle is normally dipped inside the well of the heating mantel which blocks the vision. The other drawback is that the heating mantel still gives-off undesirable heat for a while even if the power supply to the heating mantel is turned off. It is necessary to manually remove the heating mantel from the bottom of the reaction flask to avoid such problem. Particularly it is problematic when a reaction auto-accelerates and produces excessive heat. In this instance one not only wants to remove the heat source from the reaction flask quickly but also wants to cool the flask as soon as possible.

Currently, there is need for temperature control systems for laboratory use that will not have such drawbacks as described above. It is desirable to have such a temperature control system as a single unit which includes the heating device that does not radiate residual heat for a long time after the power supply to the heating mantel is turned off; a temperature controller; and optionally a cooling unit such as a built-in fan that will not hinder the observation of the reaction while it is progressing but can blow ambient cold air as needed to cool the reaction incase of auto-acceleration or over-heating conditions.

In U.S. Pat. No. 4,858,155 an apparatus for controlling reaction temperatures in a chemical analyzer has been described which comprises a thermoelectric element operating in response to a temperature sensor, and control means capable of predicting a set point deviation for a future time period, and, when an overshoot is predicted, reducing a control signal for the element by an amount proportional to a current set point deviation. The apparatus includes at least one reaction cell and a buffer unit for thermally stabilizing a fluid that is fed, on demand, into the reaction cell, the cell and the buffer unit having separate thermoelectric elements and sensors. A microcomputer control system generates independent control signals for the elements. In U.S. Pat. No. 6,467,697 a temperature control system has been described that includes an integrated circuit that combines magnetic sensitive elements and infra red sensors to detect user temperature settings and measure temperature, respectively. In U.S. Pat. No. 6,279,832 a temperature control system has been described that includes an integrated circuit that combines magnetic sensitive elements and infrared sensors to detect user temperature settings and measure temperature, respectively. Integration of the various sensors results in a very cost-effective and reliable temperature control system suitable for consumer applications. In U.S. Pat. No. 6,389,829, a temperature control system has been described that includes a simple constitution as well as be capable of strictly controlling the temperature on the side of the process device of the fluid supplied via the pathway from the chiller device. In U.S. Pat. No. 5,702,624 a heat treatment control system to cure a photoresists has been described. In U.S. Pat. No. 5,332,883 a temperature control system for lamp annealer has been described. In U.S. Pat. No. 4,646,964 a temperature control system used in association with a heating and cooling system supplying warm or cool air to a duct system for maintaining accurate temperature in a zone of multiple zones utilizing a microcomputer based thermostat for modulating a damper assembly in the duct system feeding the zone, thereby controlling the volume of air flow in the duct system to the zone to match the load in each zone has been described. In U.S. Pat. No. 4,637,454 a wide range temperature control system for controlling and maintaining the temperature of a first cooling liquid in an indirect heat exchanger at a predetermined set point within a wide range of temperatures is disclosed. In U.S. Pat. No. 6,412,551 a system for regulating the temperature of IC-chips with a fluid which is heated and cooled as a function of the fluid temperatures to and from heat exchangers for the IC-chips has been described.

### BRIEF SUMMARY OF THE INVENTION

In accordance with the present invention, a temperature controller system consists of a self contained bench top enclosure comprises a heating device which is an infrared heat producing electrical bulb; a cooling device which is a fan designed to blow ambient air; a temperature controller having input terminals that receives said input temperature signal from the target and having an electronic circuit that generates either heater control signal thus directs the infrared heat producing bulb to glow to add heat to the target until it reaches a set point or generates cooler control signal directs said fan to blow cold ambient air to the target when said temperature of the target exceeds a set point. In summary, a temperature controller generates the heater control signal and the cooler control signal as respective functions of both sensed temperatures.

This self contained temperature control system is capable of controlling temperature of a target such as a chemical reaction, polymerization, liquid, fluid, and solvent-solute system or any other matter of which the temperature needs to be controlled.

In one mode of operation, the heater adds heat to the target until the input temperature is less than the set point temperature. Then the heater shuts-off when the temperature of the target reaches or exceeds the first set point temperature. In another mode of operation, the heater not only shuts-off when the temperature of the target reaches or exceeds the first set point temperature but also the fan comes on and blows cold ambient air to the target when the input temperature or the temperature of the target exceeds the second set point temperature which is normally set a slightly higher than the first set point temperature. The temperature control system utilizes full PID control to provide accurate control of the process. The controller accepts a type J or K or any other type of thermocouple, and provides a solid state time proportioned output for heat control. To provide safety and heat interlock control the system may be equipped with alarm units. Thus upon a high temperature condition will mechanically remove power from the heater. The system is designed to work on 120VAC power or other power requirements such as available around the world.

### BRIEF DESCRIPTION OF THE DRAWINGS

FIG. 1 shows a preferred embodiment of a temperature control system in accordance with the present invention. FIG. 2 shows a preferred embodiment of a temperature control system with optionally a cooling device such as a fan in accordance with the present invention.

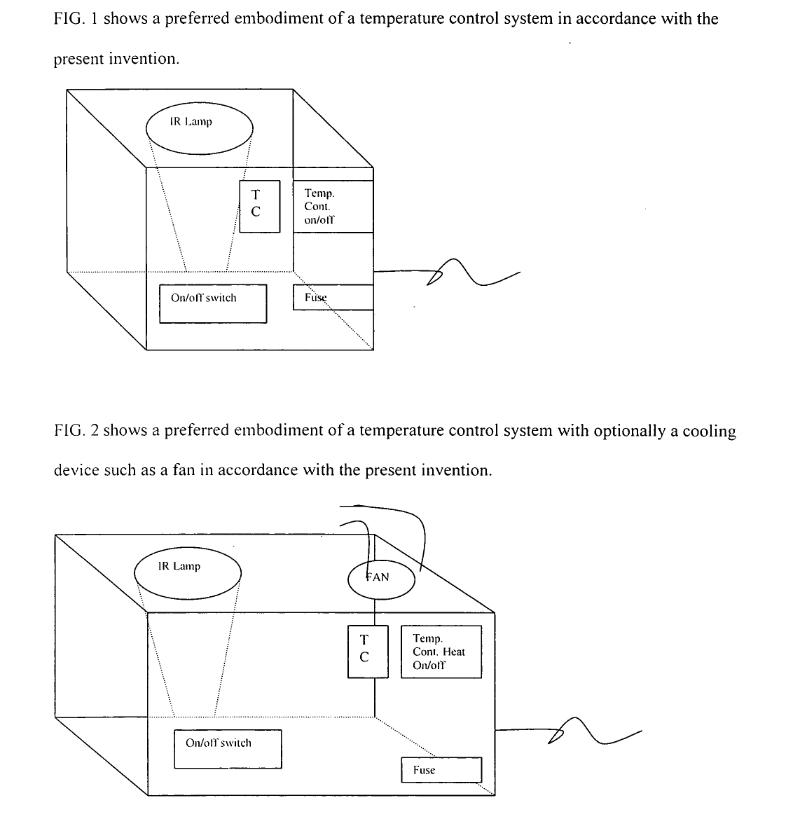

With reference now to FIG. 1, the details of a preferred embodiment of the present invention will be described. This FIG. 1 embodiment shows a self contained box that contains a temperature controller and a heating device such as an infrared heat producing electrical bulb. The box also includes an on/off switch, a socket for a thermocouple (TC), and fuse. The box may also contain alarm unit and other required electronics and wiring which are not shown. The power supply cord is also attached as shown.

With reference now to FIG. 2, the details of a preferred embodiment of the present invention will be described. This FIG. 2 embodiment shows a self contained box that contains a temperature controller and a heating device such as an infrared heat producing electrical bulb and a cooling device such as a fan. The box also includes an on/off switch, a socket for a thermocouple (TC), and fuse. The box may also contain alarm unit and other required electronics and wiring which are not shown. The power supply cord is also attached as shown.

In view of all of the above modifications, it is to be understood that the present invention is not limited to the details of the preferred embodiment of FIGS. 1 and 2, but is defined by the appended claims.

What is claimed is:

1. A system which is capable of controlling temperature of a target such as a chemical reaction, polymerization, liquid, fluid, and solvent-solute system or any other matter of which the temperature needs to be controlled, comprising at least;
a heat producing electrical bulb that is designed for producing heat;
a temperature controller having input terminals that receives said input temperature signal from the target and having an electronic circuit that generates heater control signal thus directs said heat producing electrical bulb to glow to add heat to the target until it reaches a set point;
a self contained tabletop enclosure that includes both the heating device and the temperature controller along with the necessary electronics and electrical wiring and power supply cord.

2. A system which is capable of controlling temperature of a target such as a chemical reaction, polymerization, liquid, fluid, and solvent-solute system or any other matter of which the temperature needs to be controlled, comprising at least;
a heat producing electrical bulb that is designed for producing heat;
a cooling device that is a fan designed for producing or delivering or blowing air which may be cold or at ambient temperature;
a temperature controller having input terminals that receives said input temperature signal from the target and having an electronic circuit that generates either heater control signal thus directs said heat producing electrical bulb to glow to add heat to the target until it reaches a set point or generates cooler control signal directs said fan to blow cold or ambient air to the target when said temperature of the target exceeds a set point;
a self contained tabletop enclosure that includes the heating device, the cooling device, and the temperature controller along with the necessary electronics and electrical wiring and power supply cord.

3. A system which is capable of controlling temperature of a target such as a chemical reaction, polymerization, liquid, fluid, and solvent-solute system or any other matter of which the temperature needs to be controlled, comprising
a heating device which is an infrared heat producing electrical bulb;
a cooling device which is a fan designed to blow ambient air;
a temperature controller having input terminals that receives said input temperature signal from the target and having an electronic circuit that generates either heater control signal thus directs said heater or infrared heat producing bulb to glow to add heat to the target until it reaches a set point or generates cooler control signal directs said fan to blow cold ambient air to the target when said temperature of the target exceeds a set point;
a self contained tabletop enclosure that includes the infrared lamp, fan, the temperature controller,
ports for the thermocouple along with the necessary electronics and electrical wiring and power supply cord.
